(19) United States
(12) Patent Application Publication
(10) Pub. No.: US 2016/0132783 A1
(43) Pub. Date: May 12, 2016

(54) User Modelling by Domain Adaptation

(71) Applicant: Google Inc., Mountain View, CA (US)

(72) Inventors: Huazhong Ning, San Jose, CA (US); Cheng Sheng, Fremont, CA (US); Wei Chai, Cupertino, CA (US)

(21) Appl. No.: 14/614,671

(22) Filed: Feb. 5, 2015

Related U.S. Application Data
(60) Provisional application No. 62/077,131, filed on Nov. 7, 2014.

(51) Int. Cl. G06N 7/00

(52) U.S. Cl. CPC G06N 7/005

(57) ABSTRACT

A system and method of determining sets of related terms in a target domain based on a probability of co-occurrence in a source domain user model and a target domain user model of a same user, creating an adapted user model for a first user based on the sets of related terms, and merging the adapted user model with a target domain user model for the first user to form a merged user model for the first user.

### BACKGROUND

For various systems that provide a user with personalization functionality (e.g., personalized recommendations, etc.), a user model may be built to represent the user's interests. Based on a user model, a system may provide content and/or recommendations which are likely to be relevant or attractive to the user. A user model may be built based on a specific domain. A user of one such system may likewise be a user in another such system, therefore multiple user models may exist associated with a single user across various systems.

### BRIEF SUMMARY

According to an embodiment of the disclosed subject matter, a computer-based method of determining a user model, may include determining, for each of a plurality of first terms in a source domain, a corresponding set of related terms in a target domain based on a probability that the first terms and the related terms co-occur in a source domain user model and a target domain user model of the same user, creating an adapted user model for a first user based on the sets of related terms which correspond to terms of a source domain user model for the first user, and merging the adapted user model with a target domain user model for the first user to form a merged user model for the first user.

According to an embodiment of the disclosed subject matter, a system may include a storage device, a memory that stores computer executable components, and a processor that executes computer executable components stored in the memory, including a storing component that stores first domain term data in the storage device, an interface component that receives second domain term data from an external source, a scoring component that calculates at least one co-occurrence score corresponding with at least one cross-domain pair of terms between the first domain term data and the second domain term data, the co-occurrence score indicating a probability of the corresponding pair of terms co-occurring in a first domain user model and a second domain user model of a same user, a selecting component that, for each term of a first domain user model of a first user, selects a set of related terms from among the second domain term data based on the co-occurrence scores, an aggregating component that compiles the sets of related terms into an adapted user model, and a merging component that merges the adapted user model with a second domain user model of the first user to create a merged user model for the first user.

According to an embodiment of the disclosed subject matter, means for determining, for each of a plurality of first terms in a source domain, a corresponding set of related terms in a target domain based on a probability that the first terms and the related terms co-occur in a source domain user model and a target domain user model of the same user, creating an adapted user model for a first user based on the sets of related terms which correspond to terms of a source domain user model for the first user, and merging the adapted user model with a target domain user model for the first user to form a merged user model for the first user are provided.

Additional features, advantages, and embodiments of the disclosed subject matter may be set forth or apparent from consideration of the following detailed description, drawings, and claims. Moreover, it is to be understood that both the foregoing summary and the following detailed description are illustrative and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1 shows a computing device according to an embodiment of the disclosed subject matter.

FIG. 2 shows a network configuration according to an embodiment of the disclosed subject matter.

FIG. 3 shows an illustrative source domain and target domain according to an embodiment of the disclosed subject matter.

FIG. 4 shows a processor and components according to an embodiment of the disclosed subject matter.

FIG. 5 shows a flowchart of determining related terms Rₐ according to an embodiment of the disclosed subject matter.

FIG. 6 shows a flowchart of determining an adapted user model Aᵢ according to an embodiment of the disclosed subject matter.

FIG. 7 shows an example network and system configuration according to an embodiment of the disclosed subject matter.

### DETAILED DESCRIPTION

Various aspects or features of this disclosure are described with reference to the drawings, wherein like reference numerals are used to refer to like elements throughout. In this specification, numerous details are set forth in order to provide a thorough understanding of this disclosure. It should be understood, however, that certain aspects of disclosure may be practiced without these specific details, or with other methods, components, materials, etc. In other instances, well-known structures and devices are shown in block diagram form to facilitate describing the subject disclosure.

A given system may have an associated domain within which users of the system interact with the system. The domain may be realized in part by storing data representative of a set of terms that describe various aspects of the system, for example, services, products or functions of the system associated with domain.

For a user of the system, a user model may be created for the domain using data representing a subset of the domain terms, with each of the subset terms being assigned associated weight values that indicate the user's relative interests. A user model may be built using data obtained from or associated with services and/or functions of the system. For example and without limitation, a system that includes a video viewing site may include a domain of terms representing videos stored within the system and viewing statistics of the videos. In this scenario a user model may be built based on data of a user's video watching preferences and history. A system that includes an application store may build a user model based on data tracking a user's downloading, installation and browsing histories.

Generally, domain terms may be defined by any type of term space, for example, a pure text space, e.g., “shooter game”, or an entity space such as a freebase entity, e.g., “entity:/m/01w362” (social network), or “entity:/m/0fj7z” (instant messaging). Different domains may have different types of terms and/or different terms, and may be used by different systems offered by a single provider or by associated providers. Over the course of time a user may periodically create accounts on a plurality of systems, thereby triggering the creation of multiple user models associated with the same user. The user having multiple user accounts may encounter the scenario in which one user account may have an extensive history of heavy use in a first system domain and, a second account in a different system has a short history of light use in a second system domain. Correspondingly, the user's user model for the first domain may provide higher accuracy in representation of the user's interests in the first domain compared to the accuracy of the user's user model in the second domain.

In any situation in which there may be an imbalance of accuracy between user models in a first and second domain, the coverage and accuracy of the user model in the lower accuracy domain may be improved based on the user model in the higher accuracy domain. Various approaches may be used in attempt to achieve this. For example, user data obtained from the more developed user model in the first domain, i.e., a source domain, may be directly used in the second domain, i.e., a target domain. However, this approach may lead to an increase in user modelling complexity due to the mixing of data from multiple sources, and may raise privacy concerns which may block the access to user data.

An alternative approach could be to copy the user model terms from the source domain to the target domain. However, this approach may be problematic due to the source domain and the target domain having different types of terms. Even if the source domain and target domain use the same type of terms, they may have different preferred subsets of terms. For example, the aforementioned video viewing site domain may prefer terms such as “country music” or “action movie,” while the aforementioned application store domain may prefer terms such as “puzzle games” or “shooter games.”

The present subject disclosure presents approaches to improve a user model in a target domain by first adapting a user model in a source domain to the target domain and then merging the adapted model to the original user model in the target domain. According to the embodiments described herein, the accuracy of the user model in the target domain may be increased while overcoming the problems and disadvantage described in the alternative possible approaches to leveraging the accuracy of the user model in the source domain.

In situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a system as disclosed herein.

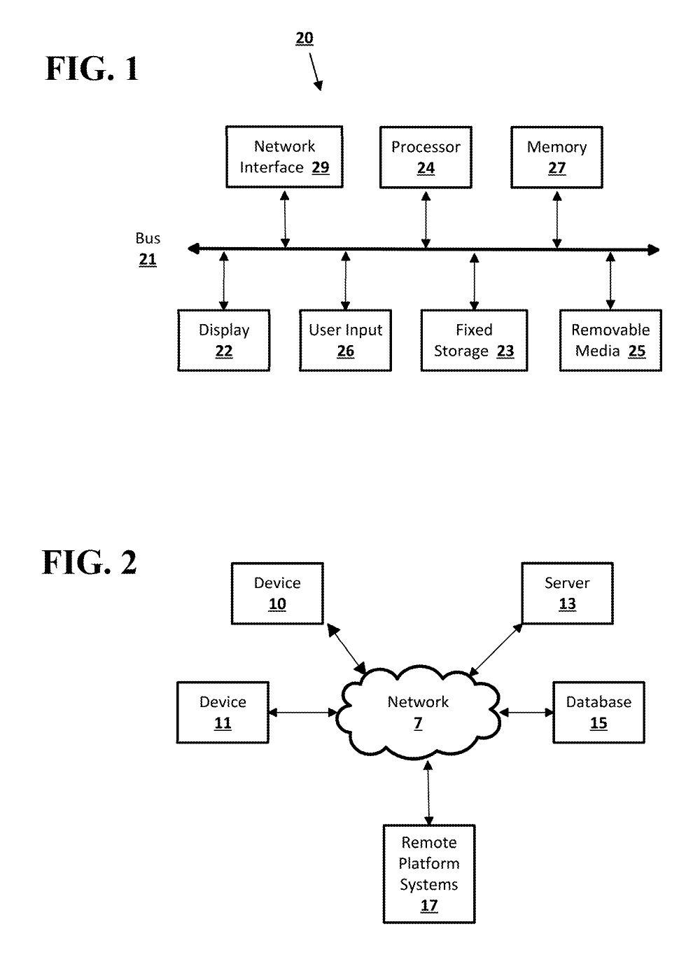

Embodiments of the presently disclosed subject matter may be implemented in and used with a variety of component and network architectures. FIG. 1 is an example computing device 20 suitable for implementing embodiments of the presently disclosed subject matter. The device 20 may be, for example, a desktop or laptop computer, or a mobile computing device such as a smart phone, tablet, or the like. The device 20 may include a bus 21 which interconnects major components of the computer 20, such as a central processor 24, a memory 27 such as Random Access Memory (RAM), Read Only Memory (ROM), flash RAM, or the like, a user display 22 such as a display screen, a user input interface 26, which may include one or more controllers and associated user input devices such as a keyboard, mouse, touch screen, and the like, a fixed storage 23 such as a hard drive, flash storage, and the like, a removable media component 25 operative to control and receive an optical disk, flash drive, and the like, and a network interface 29 operable to communicate with one or more remote devices via a suitable network connection.

The bus 21 allows data communication between the central processor 24 and one or more memory components, which may include RAM, ROM, and other memory, as previously noted. Typically RAM is the main memory into which an operating system and application programs are loaded. A ROM or flash memory component can contain, among other code, the Basic Input-Output system (BIOS) which controls basic hardware operation such as the interaction with peripheral components. Applications resident with the computer 20 are generally stored on and accessed via a computer readable medium, such as a hard disk drive (e.g., fixed storage 23), an optical drive, floppy disk, or other storage medium.

The fixed storage 23 may be integral with the computer 20 or may be separate and accessed through other interfaces. The network interface 29 may provide a direct connection to a remote server via a wired or wireless connection. The network interface 29 may provide such connection using any suitable technique and protocol as will be readily understood by one of skill in the art, including digital cellular telephone, WiFi, Bluetooth®, near-field, and the like. For example, the network interface 29 may allow the computer to communicate with other computers via one or more local, wide-area, or other communication networks, as described in further detail below.

Many other devices or components (not shown) may be connected in a similar manner (e.g., document scanners, digital cameras and so on). Conversely, all of the components shown in FIG. 1 need not be present to practice the present disclosure. The components can be interconnected in different ways from that shown. The operation of a computer such as that shown in FIG. 1 is readily known in the art and is not discussed in detail in this application. Code to implement the present disclosure can be stored in computer-readable storage media such as one or more of the memory 27, fixed storage 23, removable media 25, or on a remote storage location.

FIG. 2 shows an example network arrangement according to an embodiment of the disclosed subject matter. One or more devices 10, 11, such as local computers, smart phones, tablet computing devices, and the like may connect to other devices via one or more networks 7. Each device may be a computing device as previously described. The network may be a local network, wide-area network, the Internet, or any other suitable communication network or networks, and may be implemented on any suitable platform including wired and/or wireless networks. The devices may communicate with one or more remote devices, such as servers 13 and/or databases 15. The remote devices may be directly accessible by the devices 10, 11, or one or more other devices may provide intermediary access such as where a server 13 provides access to resources stored in a database 15. The devices 10, 11 also may access remote platform systems 17 or services provided by remote platform systems 17 such as cloud computing arrangements and services. The remote platform systems 17 may include one or more servers 13 and/or databases 15.

The remote platform systems 17 may have respective domains, such as, for example, a system for operating a video viewing site or a system for operating an application store site. Users of the systems 17 may access the systems 17, for example, via the one or more networks 7. As mentioned above, users may establish accounts with the systems 17. User data associated with the accounts may be stored, for example, in database 15. User data may include the user account information as well as user models built for each user of the respective systems.

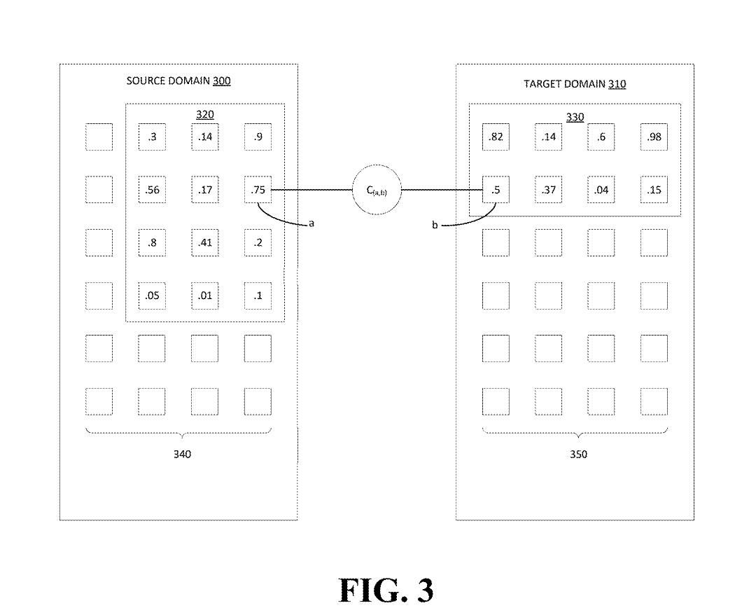

Referring to FIGS. 2 and 3, an illustrative scenario will be addressed in which systems 17 include at least two individual systems, i.e., a source and a target system having a corresponding source domain 300 and a target domain 310. Source domain 300 may include a term space having plurality of terms 340, and target domain 310 may include a term space having a plurality of terms 350. When a user creates a user account with the system of the source domain 300, the system of the source domain 300 builds a first user model 320 which includes a subset of terms 340 which are associated with the user. The system assigns weight values to each of the terms in user model 320 in accordance with the user's interests. The weight values may be, for example, “0.3”, “0.14”, “0.9”, etc., as illustrated in FIG. 3, or some other suitable weight value system.

At another point in time, the user may create an account with the system of the target domain 310, resulting in the building of a second user model 330 which includes a subset of weighted terms 350.

The user models 320 and 330 may be dynamically maintained and periodically adjusted to reflect the user's current interests. For example, additional terms 340, 350 may be added to the user model 320, 330, obsolete terms may be removed, and/or respective weighting values may be increased or decreased. Given the scenario that the user model 320 is more developed and accurate than user model 330, for example, due to the user's habits, more active behavior patterns, longer history, preferences, etc., user model 330 may be improved by adapting user model 320 to user model 330 and merging the adapted model with user model 330 to build a final improved user model for the user in target domain 310.

An illustrative scenario and system according to an embodiment of the present general inventive concept will now be described. An illustrative system 17 may store data which represents source domain 300 and/or target domain 310, however, the particular location of the data is not critical provided the data is accessible. Thus, the specific execution of the functions of the present disclosure may be carried out in various ways without falling out of the scope of the present general inventive concept.

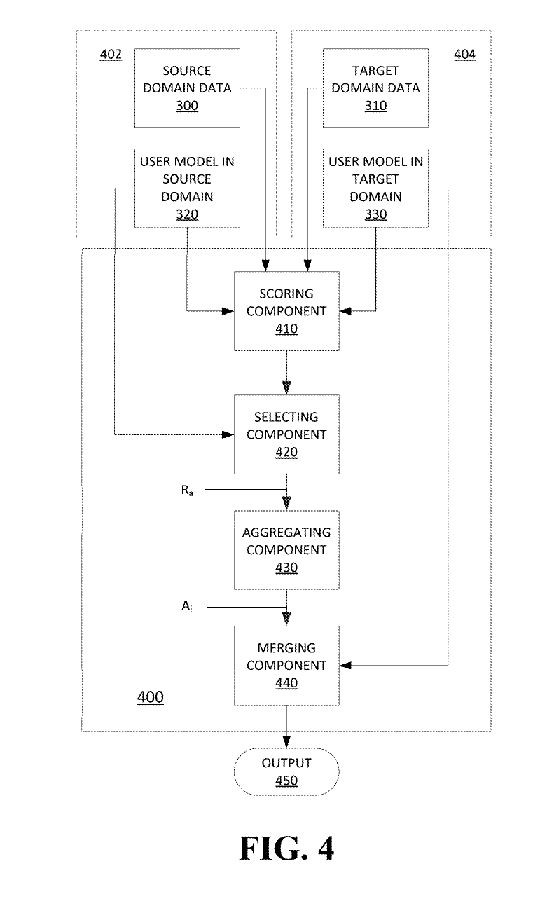

Referring to FIG. 4, an illustrative processor 400 according to the present disclosure is illustrated. The processor 400 includes a scoring component 410, a selecting component 420, an aggregating component 430 and a merging component 440. Processor 400 may receive source domain data 300 and source domain user model data 320 from an external source 402, e.g., a system 17 in which a user has a well-developed user model 320. Processor 400 may receive target domain data 310 and target domain user model data 330 from a storing component 404. Storing component 404 may, for example, function to manage data stored locally, e.g., fixed storage 23 in FIG. 1, or accessible to the system 17, e.g., database 15 in FIG. 2. The configuration of data 300, 310, 320 and 330 and the retrieval thereof is merely an example configuration for illustrative purposes.

Scoring component 410 may receive data 300, 310, 320 and 330 and calculate a co-occurrence score C between cross-domain pairs of terms (a, b) between the source domain 300 and target domain 310. Co-occurrence score C may indicate a probability that both of terms (a, b) occur in user models of a same user. Referring to the example shown in FIG. 3, source domain user model 320 and target domain user model 300 are associated with a same user i. Term a, within source domain 300, therefore co-occurs with term b within target domain 310, since both of the terms occur in user models of the same user i.

Scoring component 410 may determine a co-occurrence score C for a plurality of pairs of terms (a, b) in source domain 300 and target domain 310. For example, sets of terms may be designated in each of source domain 300 and target domain 310 for co-occurrence score calculation. Alternatively, scoring component 410 may determine a co-occurrence score C for each pair of cross-domain terms in domains 300 and 310. The co-occurrence score C may be based on how often the terms (a, b) co-occur over a plurality of users, e.g., (i, j), of domains 300 and 310. For example, co-occurrence score C may be determined by mutual information, as follows:

C_{(a,b)}=Σ_{iε{a,!a}}Σ_{jε{b,!b}}P(i,j)log(P(i,j)/(P(i)P(j))) Eq. 1

where a means that term a appears in the source domain user model, !a means that term a does not appear in the source domain user model, b means that the term b appears in the target domain user model, !b means that term b does not appear in the target domain user model and P(.) are probabilities approximated by counting term occurrences and co-occurrences over a plurality of users.

Selecting component 420 may select a set of terms within the target domain 310 which are deemed to be related to source domain 300 based on the co-occurrence scores. For example, for each term a in a source domain user model 320, the selecting component 420 may select a set of related terms Rₐ from among the target domain 310 based on the co-occurrence scores C(a, b). The selecting component 420 is not limited in the method of selecting the sets of related terms Rₐ based on the co-occurrence scores. For example, the selecting component 420 may select each set of related terms Rₐ by sorting the target domain 310 terms that co-occur with source domain 300 term a according to their respective co-occurrence scores in descending order and selecting the highest N number of target domain 310 terms, where N is a predetermined number.

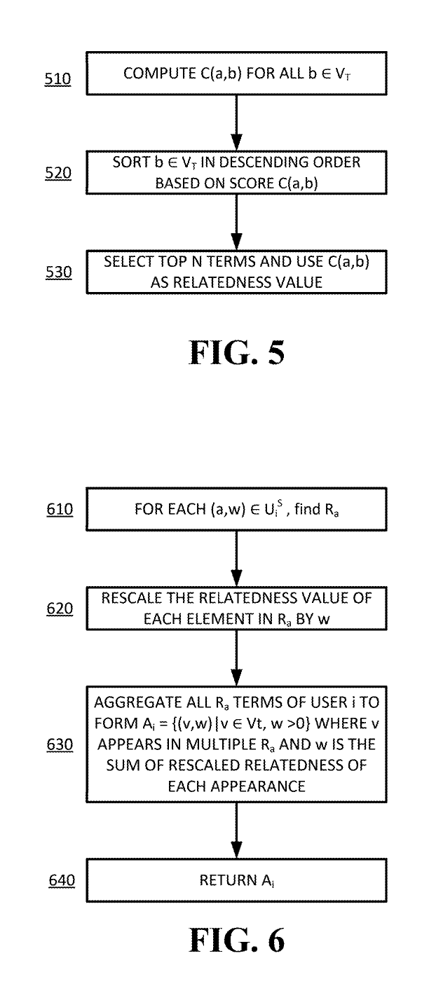

An illustrative flowchart for determining Rₐ is illustrated in FIG. 5. At operation 510, a co-occurrence score C(a, b) is determined for all terms b within a target domain V_{T}. At operation 520, the terms b within V_{T} are sorted in descending order based on to co-occurrence scores. At operation 530, the top N terms are selected to form Rₐ, each having the corresponding co-occurrence score C(a, b) as an associated relatedness value.

Referring back to FIG. 4, aggregating component 430 may aggregate the terms in the sets of related terms Rₐ to build an adapted user model Aᵢ for user i. The adapted user model Aᵢ may serve as an intermediary user model between source domain 300 and target domain 310. The aggregating component 430 may build the adapted user model Aᵢ by assigning weights to the terms of the Rₐ sets based on the respective co-occurrence scores. In one illustrative embodiment, the co-occurrence scores themselves may be directly assigned as the weight values for the terms in adapted user model Aᵢ. In another illustrative embodiment, the weight value per term is determined by rescaling the relatedness value of each term b in Rₐ based on the weight value of the associated term a in the source domain user model 320.

It is possible that a given term appears multiple times among the sets Rₐ. Using the rescaled relatedness value as described above, the weight per term in adapted user model Aᵢ may be determined by summing the rescaled relatedness value for each appearance of a given term.

An illustrative flow chart for generating adapted user model Aᵢ is illustrated in FIG. 6. At operation 610, related terms Rₐ are found for each term a having a weight w within user i source domain user model Uᵢ^{S}. At operation 620 the relatedness value of each term in Rₐ is rescaled by weight w. At operation 630 all of the Rₐ terms of user i are aggregated into a set of terms v, each term having an associated weight value w. The weight value for terms v may be determined by summing the relatedness value for each appearance of term v.

Referring back to FIG. 4, merging component 440 may merge the adapted user model Aᵢ with the target domain user model 330. The merging accounts for the respective weight values associated with terms in each model and produces an output 450, i.e., a merged user model. The merging component may merge the adapted user model Aᵢ with the target domain user model 330, for example, by summing the weights of each term in the adapted user model Aᵢ and the target domain user model 330 and selecting a predetermined number of terms having the resultant highest weight values as terms for the merged user model for the user i.

Accordingly, an improved merged user model may be created. The merged user model may present a more accurate representation of a user's interests in a target domain and, therefore, may be used to provide more accurate predictions regarding a user's interests, to provide more relevant information or options to the user, to more readily identify content that the user would not want to view or would wish to block (such as “spam” content), or the like. For example, based on a merged user model as described herein, a system may select content to provide or recommend to a user which is likely to be more relevant or interesting to the user. As such, personalization of a user's experience in using the system may be improved.

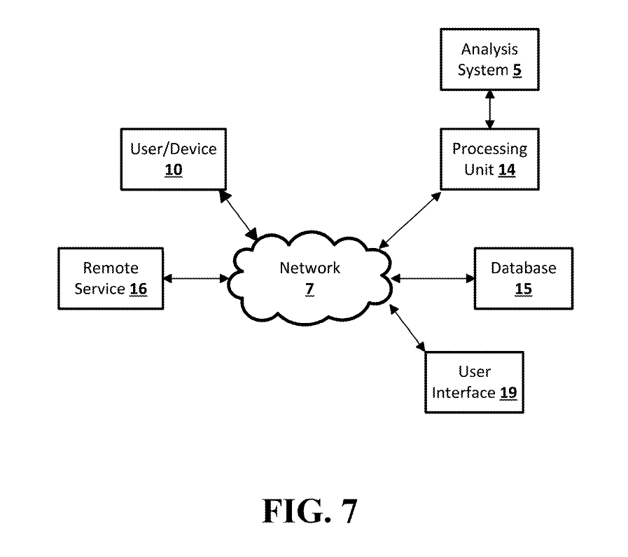

FIG. 7 shows an example arrangement according to an embodiment of the disclosed subject matter. One or more devices or systems 10, 16, such as remote services or service providers 16, user devices 10 such as local computers, smart phones, tablet computing devices, and the like, may connect to other devices via one or more networks 7. The network may be a local network, wide-area network, the Internet, or any other suitable communication network or networks, and may be implemented on any suitable platform including wired and/or wireless networks. The devices 10, 16 may communicate with one or more remote computer systems, such as processing units 14, databases 15, and user interface systems 19. In some cases, the devices 10, 11 may communicate with a user-facing interface system 19, which may provide access to one or more other systems such as a database 15, a processing unit 14, or the like. For example, the user interface 19 may be a user-accessible web page that provides data from one or more other computer systems. The user interface 19 may provide different interfaces to different clients, such as where a human-readable web page is provided to a web browser client on a user device 10, and a computer-readable API or other interface is provided to a remote service client 16.

The user interface 19, database 15, and/or processing units 14 may be part of an integral system, or may include multiple computer systems communicating via a private network, the Internet, or any other suitable network. One or more processing units 14 may be, for example, part of a distributed system such as a cloud-based computing system, search engine, content delivery system, or the like, which may also include or communicate with a database 15 and/or user interface 19. In some arrangements, an analysis system 5 may provide back-end processing, such as where stored or acquired data is pre-processed by the analysis system 5 before delivery to the processing unit 14, database 15, and/or user interface 19. For example, a machine learning system 5 may provide various prediction models, data analysis, or the like to one or more other systems 19, 14, 15. Analysis system 5 may include, for example, the processor 400 illustrated in FIG. 4.

More generally, various embodiments of the presently disclosed subject matter may include or be embodied in the form of computer-implemented processes and apparatuses for practicing those processes. Embodiments also may be embodied in the form of a computer program product having computer program code containing instructions embodied in non-transitory and/or tangible media, such as floppy diskettes, CD-ROMs, hard drives, USB (universal serial bus) drives, or any other machine readable storage medium, such that when the computer program code is loaded into and executed by a computer, the computer becomes an apparatus for practicing embodiments of the disclosed subject matter. Embodiments also may be embodied in the form of computer program code, for example, whether stored in a storage medium, loaded into and/or executed by a computer, or transmitted over some transmission medium, such as over electrical wiring or cabling, through fiber optics, or via electromagnetic radiation, such that when the computer program code is loaded into and executed by a computer, the computer becomes an apparatus for practicing embodiments of the disclosed subject matter. When implemented on a general-purpose microprocessor, the computer program code segments configure the microprocessor to create specific logic circuits.

In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Embodiments may be implemented using hardware that may include a processor, such as a general purpose microprocessor and/or an Application Specific Integrated Circuit (ASIC) that embodies all or part of the techniques according to embodiments of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to embodiments of the disclosed subject matter.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. A computer-based method of determining a user model, comprising:
determining, for each of a plurality of first terms in a source domain, a corresponding set of related terms in a target domain based on a probability that the first terms and the related terms co-occur in a source domain user model and a target domain user model of a same user;
creating an adapted user model for a first user based on the sets of related terms which correspond to terms of a source domain user model for the first user; and
merging the adapted user model with a target domain user model for the first user to form a merged user model for the first user.

2. The method of claim 1, further comprising selecting content to recommend to the first user based on the merged user model for the first user.

3. The method of claim 1, wherein the adapted user model, the source domain user model for the first user, and the target domain user model for the first user each comprise a respective set of terms, each term having an associated weight value.

4. The method of claim 3, wherein merging the adapted user model with the target domain user model comprises:
summing the weights of each term in the adapted user model and the target domain user model; and
selecting a predetermined number of terms having the resultant highest weight values as terms for the merged user model for the first user.

5. The method of claim 1, wherein determining the set of related terms comprises:
determining, for each cross-domain pair of terms between the source domain and the target domain, a co-occurrence score which indicates a probability that the pair of terms will co-occur in user models associated with a single user; and
selecting a predetermined number of the target domain terms as the set of related terms based on the co-occurrence scores.

6. The method of claim 5, wherein selecting the predetermined number of target domain terms comprises selecting a predetermined number of highest scoring target domain scores per source domain term.

7. The method of claim 5, wherein the co-occurrence score is determined by mutual information as follows:
C_{(a,b)}=Σ_{iε{a,!a}}Σ_{jε{b,!b}}P(i,j)log(P(i,j)/(P(i)P(j)))
where a means that term a appears in the source domain user model, !a means that term a does not appear in the source domain user model, b means that the term b appears in the target domain user model, !b means that term b does not appear in the target domain user model and P(.) are probabilities approximated by counting term occurrences and co-occurrences over a plurality of users.

8. The method of claim 5, wherein creating the adapted user model comprises:
determining a set of related terms for each term in the source domain user model;
determining a relatedness value for each of the related terms based on the co-occurrence score and the weight value of the associated source domain user model term;
aggregating all of the sets of related terms; and
determining a weight value for each term by summing the relatedness value for each respective appearance of each term across all of the sets of related terms.

9. The method of claim 8, wherein the relatedness value is determined by multiplying the co-occurrence score by the weight value of the associated source domain user model term.

10. A computer based method of determining a user model, comprising:
computing, for each pair of terms bridging a first domain of terms and a second domain of terms, a corresponding co-occurrence score value which indicates a probability that the pair of terms co-occurs in different user models associated with a same user;
determining, for each term in a first domain user model of a first user, a set of related terms in the second domain of terms based on the computed co-occurrence score values;
generating an adapted user model based on the set of related terms; and
merging the adapted user model with a second domain user model of the first user to form a merged user model for the first user.

11. A system, comprising:
a storage device; a memory that stores computer executable components; and
a processor that executes the following computer executable components stored in the memory:
a storing component that stores first domain term data in the storage device;
an interface component that receives second domain term data from an external source;
a scoring component that calculates at least one co-occurrence score corresponding with at least one cross-domain pair of terms between the first domain term data and the second domain term data, the co-occurrence score indicating a probability of the corresponding pair of terms co-occurring in a first domain user model and a second domain user model of a same user;
a selecting component that, for each term of a first domain user model of a first user, selects a set of related terms from among the second domain term data based on the co-occurrence scores;
an aggregating component that compiles the sets of related terms into an adapted user model; and
a merging component that merges the adapted user model with a second domain user model of the first user to create a merged user model for the first user.

12. The system of claim 11, wherein the first domain user model, the second user domain model, the adapted user model, and the merged user model each comprise a respective set of terms, each term having an associated weight value.

13. The system of claim 12, wherein the merging component merges the adapted user model with the second domain user model by summing the weight values of each of the respective terms in the adapted user model and the second domain user model, and selecting a predetermined number of terms having the resultant highest weight values as terms for the final user model for the first user

14. The system of claim 11, wherein the selecting component selects the set of related terms by determining, for each cross-domain pair of terms between the first domain and the second domain, a co-occurrence score which indicates a probability that the terms will co-occur in a first domain user model and a second domain user model of the same user, and selecting a predetermined number of the second domain terms as the set of related terms based on the co-occurrence scores.

15. The system of claim 14, wherein the selecting component selects the predetermined number of second domain terms by selecting a predetermined number of highest scoring second domain scores per first domain term.

16. The system of claim 14 wherein the selecting component determines the co-occurrence score C by mutual information as follows:
C_{(a,b)}=Σ_{iε{a,!a}}Σ_{jε{b,!b}}P(i,j)log(P(i,j)/(P(i)P(j)))
where a means that term a appears in the first domain user model, !a means that term a does not appear in the first domain user model, b means that the term b appears in the second domain user model, !b means that term b does not appear in the second domain user model and P(.) are probabilities approximated by counting term occurrences and co-occurrences over a plurality of users.

17. The system of claim 14, wherein the aggregating component determines a set of related terms for each term in the first domain user model by determining a relatedness value for each of the related terms based on the co-occurrence score and the weight value of the associated first domain user model term, aggregating all of the sets of related terms, and determining a weight value for each term by summing the relatedness value for each respective appearance of each term across all of the sets of related terms.

18. The system of claim 17, wherein the aggregating component determines the relatedness value by multiplying the co-occurrence score by the weight value of the associated source domain user model term.
